(19) United States
(12) Patent Application Publication
(10) Pub. No.: US 2024/0334366 A1
(43) Pub. Date: Oct. 3, 2024

(54) METHOD FOR MANAGING SLICING INFORMATION IN WIRELESS NETWORK

(71) Applicant: SAMSUNG ELECTRONICS CO., LTD., Suwon-si (KR)

(72) Inventors: Lalith KUMAR, Bangalore (IN); Koustav ROY, Bangalore (IN); Danish Ehsan HASHMI, Bangalore (IN); Jagadeesh GANDIKOTA, Bangalore (IN); Krishnamurthy D R, Bangalore (IN); Ashok Kumar NAYAK, Bangalore (IN)

(21) Appl. No.: 18/622,669

(22) Filed: Mar. 29, 2024

(30) Foreign Application Priority Data
Mar. 30, 2023 (IN) 202341024021
Mar. 15, 2024 (IN) 202341024021

(51) Int. Cl. H04W 60/04; H04W 60/06

(52) U.S. Cl. CPC H04W 60/04; H04W 60/06

(57) ABSTRACT

The disclosure relates to a 5G or 6G communication system for supporting a higher data transmission rate. Embodiments disclosed herein provide method for managing a Network Slice Selection Assistance Information (NSSAI) list in a wireless network by a UE. The method includes receiving at least one event. The at least one event includes: receiving a deregistration request message from a network function (NF) entity, performing a deregistration event at the UE, or successfully completing a tracking area update procedure, a successful registration procedure, or an unsuccessful registration procedure. Further, the method includes deleting: a partially rejected NSSAI list or a partially allowed NSSAI list based on the at least one received event.

### CROSS-REFERENCE TO RELATED APPLICATIONS

This application is based on and derives the benefit of an Indian Provisional Application Number 202341024021, filed on Mar. 30, 2023, and of an Indian Complete Application Number 202341024021, filed on Mar. 15, 2024, in the Indian Intellectual Property Office, the contents of which are incorporated herein by reference.

### BACKGROUND

### 1. Field

The embodiments disclosed herein generally relate to the field of a wireless network, and more particularly, to a User Equipment (UE) and a method to update partially allowed Network Slice Selection Assistance Information (NSSAI) list in the wireless network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The network slice may be supported in one or more Tracking Areas (TAs) in a Public Land Mobile Network (PLMN) or Standalone Non-Public Network (SNPN) PLMN/SNPN. The partial network slice support in a registration area for the UE includes configuring the UE with the partially allowed NSSAI and/or Single-NSSAI(s) (S-NSSAI(s)) rejected partially in a Registration Area (RA). Partially Allowed NSSAI indicates a S-NSSAIs values, a UE could use in serving PLMN/SNPN in some of TAs in a current RA. Each S-NSSAI in a partially allowed NSSAI is associated with a list of TAs where the S-NSSAI is supported. Alternatively, an Access and Mobility Function (AMF) may reject the S-NSSAI(s) with reject cause indicating “partially in the RA”. For each S-NSSAI of the S-NSSAIs rejected partially in the RA the AMF provides a list of Tas where the S-NSSAI is not supported. When creating a registration area for the UEs registering over the Third Generation Partnership Project (3GPP) access and supporting the partial network slice support in the registration area, an AMF entity may consider the trade-off between signalling for paging in TAs where the S-NSSAI is not supported versus the signalling for mobility registration updates to register with the S-NSSAI in the TA(s) where the S-NSSAI is supported, so that the AMF entity may create a registration area including the TA(s) where the requested S-NSSAI is not supported. For such S-NSSAI the AMF provides either the Partially Allowed NSSAI and the S-NSSAIs rejected partially in the RA so that the UE can remain registered in the larger registration area and at the same time use the S-NSSAI in the subset of Tracking Area Identifiers (TAIs) where the respective S-NSSAI is supported. Once the list is provided to the UE, there are situations where the UE may leave the system where it received the respective list or it may deregister with the network. When such an event occurs, how the UE should manage with the one or more NSSAI lists is not well defined and may lead to the UE not requesting for its desired S-NSSAI and losing the respective service of the S-NSSAI. Its desirable to solve such issues.

FIG. 1 illustrates a sequence diagram depicting a scenario where the UE (100) sends the registration request message without including the S-NSSAI-1 in the requested NSSAI list in the wireless network (1000) and is not able to get the services offered due to S-NSSAI-1, according to the prior art. At step 1, the UE (100) sends an uplink (UL) Non-Access Stratum (NAS) message e.g., the registration request message including the S-NSSAI-1 in the requested NSSAI list to the network function entity (200). At step 2, in response to the UL NAS message, the network function entity (200) sends a downlink (DL) NAS message e.g., registration accept including the S-NSSAI-1 in the partially allowed NSSAI list or partially rejected NSSAI list indicating supported list of TAs as TA-1 and TAI-2 (as not supported) and the current registration area includes the TA-1 and the TA-2. At step 3, the UE (100) moves to the TA-2 from the TA-1. At step 4, the network function entity (200) sends the DL NAS message e.g., deregistration request message to the UE (100). At step 5, in response to the deregistration request, the UE (100) sends the UL NAS message e.g. deregistration accept to the network function entity (200). At step 6, the UE (100) sends the UL NAS message e.g., registration request message to register with the network without including the S-NSSAI-1 in the requested NSSAI list as the S-NSSAI-1 is in the partially allowed NSSAI list or the partially rejected NSSAI list of the UE (100) and the UE (100) is the area (TAI) where the S-NSSAI-1 is not supported based on the partially allowed NSSAI list or partially rejected NSSAI list.

The above information is presented as background information only to help the reader to understand the present disclosure. Applicants have made no determination and make no assertion as to whether any of the above might be applicable as prior art with regard to the present application.

The principal object of the embodiments herein is to provide a UE and a method to update partially allowed and/or the S-NSSAIs rejected partially in a registration Area and/or S-NSSAI location availability information or Allowed NSSAI list.

Another object of the embodiments herein is to provide that the UE deletes the partially rejected NSSAI list when the UE receives a deregistration request from a Network Function (NF) entity or deregisters from the UE.

Another object of the embodiments herein is to provide that when the UE perform intersystem change from a 5GS to an Evolved Packet System (EPS), the UE sends a Tracking Area Update (TAU) request and receives a TAU accept message or a TAU reject message. That is, the UE successfully completes tracking area update procedure then, the UE deletes partially rejected NSSAI list.

Another object of the embodiments herein is to provide that when the UE moves out of the registration area, the UE performs the successful or unsuccessful registration procedure, then the UE deletes partially rejected NSSAI list.

### SUMMARY

Embodiments disclosed herein provide a method for managing a Network Slice Selection Assistance Information (NSSAI) list in a wireless network. The method includes receiving, by a UE, at least one event. The at least one event includes: receive a deregistration request message from a network function (NF) entity e.g., AMF, perform a deregistration event (also called the procedure) at the UE, successfully complete a tracking area update procedure, a successful registration procedure, an unsuccessful registration procedure, or an unsuccessful tracking area update procedure. Further, the method includes deleting, by the UE, a partially rejected NSSAI list or a partially allowed NSSAI list based on the at least one received event.

Embodiments disclosed herein provide a UE for managing an NSSAI list in a wireless network. The UE includes a NSSAI list managing controller coupled with a memory and a processor. The NSSAI list managing controller is configured to receive at least one event. The at least one event comprises: receive a deregistration request message from a NF entity, perform a deregistration event at the UE, successfully complete a tracking area update procedure, a successful registration procedure, or an unsuccessful registration procedure. Further, the NSSAI list managing controller is configured to delete a partially rejected NSSAI list or a partially allowed NSSAI list based on the at least one received event.

In an embodiment, the tracking area update procedure is successfully completed by performing an intersystem change from a N1 mode to a S1 mode, sending a Tracking Area Update (TAU) request message to the NF entity while performing the intersystem change from the N1 mode to the S1 mode, and receiving one of: a TAU accept message or a TAU reject message based on the TAU request message.

In an embodiment, the successful registration procedure or the unsuccessful registration procedure is performed when the UE moves out of a registration area.

In an embodiment, the UE enters a 5GMM-DEREGISTERED state or a 5GMM-REGISTERED state.

In an embodiment, the NSSAI list is received over a DL NAS message, and wherein the DL NAS message is a UE configuration update command message or a registration accept message.

In an embodiment, the deregistration event performed at the UE is due to UE initiated deregistration procedure or a network initiated deregistration procedure.

In an embodiment, the partially rejected NSSAI list or the partially allowed NSSAI represent the S-NSSAI which are not supported in the complete registration area and indicate whether the S-NSSAI is supported or not supported on at least one of the TAI.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

The proposed method and the UE are illustrated in the accompanying drawings, throughout which like reference letters indicate corresponding parts in the various figures. The embodiments herein will be better understood from the following description with reference to the drawings, in which:

FIG. 1 illustrates a sequence diagram depicting a scenario of a UE sending a registration request message without including S-NSSAI-1 in the requested NSSAI list in a wireless network, according to the prior art;

FIG. 2 illustrates a sequence diagram depicting a scenario of the UE deleting a partially allowed or partially rejected NSSAI list in the wireless network, according to the embodiments as disclosed herein;

FIG. 3 illustrates a sequence diagram depicting a solution where stored S-NSSAI is deleted from the partially allowed NSSAI list and/or the S-NSSAIs rejected partially in the RA of the UE in the wireless network, according to embodiments as disclosed herein;

FIG. 4 illustrates various hardware components of the UE, according to the embodiments as disclosed herein; and

FIG. 5 illustrates a flow chart depicting a method for managing the NSSAI list in the wireless network, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the one or more elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

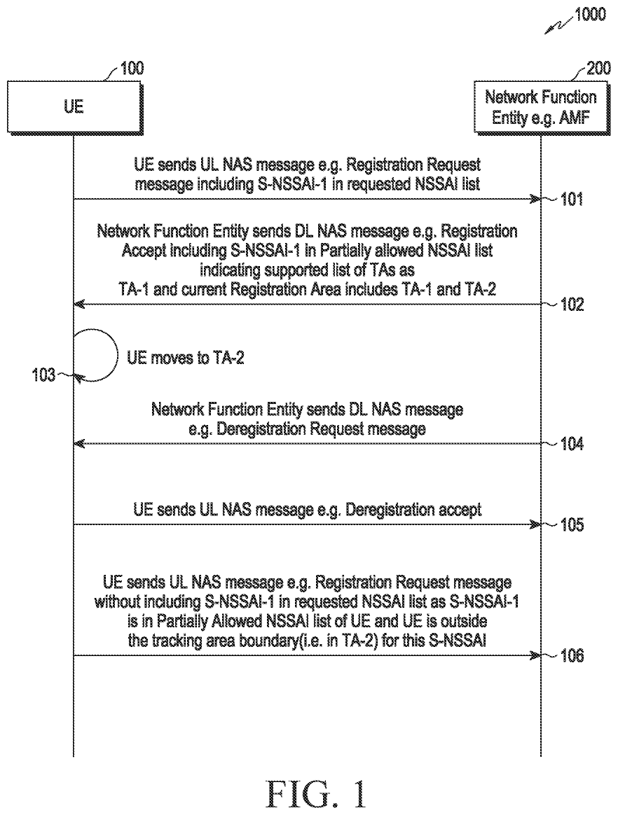

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The abbreviations used in the description—
a) UE—User Equipment
b) DL—Downlink
c) NR—New radio
d) NG—Next generation
e) 5G—5th generation
f) RA—Radio Access
g) RAN—Radio access network
h) E-UTRAN—Evolved Universal Mobile Telecommunications RAN
i) LTE—Long-Term Evolution
j) NAS—Non-Access-Stratum
k) AMF entity—Access and Mobility Management Function entity
l) NSSAI—Network Slice Selection Assistance Information
m) TAs—Tracking area
n) 3GPP—Third Generation Partnership Project
o) TAI—Tracking Area Identifier

The term 5GMM sublayer states in the embodiment are at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
   g) 5GMM-DEREGISTERED.eCALL-INACTIVE
   h) 5GMM-DEREGISTERED.INITIALREGISTRATIONNEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED
1. 5GMM-IDLE mode: In the specification, when the term is used standalone, a UE in 5GMM-IDLE mode means the UE can be either in 5GMM-IDLE mode over 3GPP access or in 5GMM-IDLE mode over non-3GPP access.
2. 5GMM-CONNECTED mode: In the specification, when the term is used standalone, the UE in 5GMM-CONNECTED mode means the UE can be either in 5GMM-CONNECTED mode over 3GPP access or in 5GMM-CONNECTED mode over non-3GPP access.
3. 5GMM-IDLE mode over 3GPP access: The UE is in 5GMM-IDLE mode over 3GPP access when no N1 NAS signalling connection between the UE and network over 3GPP access exists. The term 5GMM-IDLE mode over 3GPP access used in the present document corresponds to the term CM-IDLE state for 3GPP access used in 3GPP TS 23.501.
4. 5GMM-CONNECTED mode over 3GPP access: The UE is in 5GMM-CONNECTED mode over 3GPP access when an N1 NAS signalling connection between the UE and network over 3GPP access exists. The term 5GMM-CONNECTED mode over 3GPP access used in the present document corresponds to the term CM-CONNECTED state for 3GPP access used in 3GPP TS 23.501.

Embodiments disclosed herein provide a method and a UE for managing a NSSAI list in a wireless network. The method includes receiving, by the UE, an event. The event includes at least one of: receive a deregistration request message from a NF entity, perform a deregistration event at the UE, successfully complete a tracking area update procedure, a successful registration procedure or an unsuccessful registration procedure. Further, the method includes deleting, by the UE, a partially rejected NSSAI list or a partially allowed NSSAI list based on the at least one received event.

In another embodiment, the UE sends the UL NAS message e.g., registration request message including S-NSSAI-1 in a requested NSSAI list to the network function entity. In response to the registration request message from the UE, the network function entity sends the DL NAS message e.g., registration accept including S-NSSAI-1 in the partially allowed NSSAI list or in the partially rejected NSSAI list indicating a supported list of TAs as TA-1, not supported as TA-2 and current registration area includes TA-1 and TA-2. The UE moves from the TA-1 to the TA-2. The network function entity sends the DL NAS message e.g., deregistration request message. In the proposed method, the UE deletes the partially allowed or the partially rejected NSSAI list. The UE sends a UL NAS message e.g., deregistration accept. The UE sends the UL NAS message with the registration request message including the S-NSSAI-1 in the requested NSSAI list as the S-NSSAI-1 is deleted from the partially allowed NSSAI list and/or the S-NSSAIs rejected partially in the RA of the UE.

In the proposed method, the UE deletes an S-NSSAI-1 from the partially allowed NSSAI list and/or the S-NSSAIs rejected partially in the RA and the UE sends a UL NAS message e.g., registration request message including the S-NSSAI-1 in the requested NSSAI list as the S-NSSAI-1 is deleted from the partially allowed NSSAI list and/or the S-NSSAIs rejected partially in the RA of the UE. During deregistration, the UE deletes the partially allowed list and/or the S-NSSAIs rejected partially in the RA and sends the UL NAS message e.g., the registration request message including the S-NSSAI-1 in the requested NSSAI list as the S-NSSAI-1 is deleted from the partially allowed NSSAI list and/or the S-NSSAIs rejected partially in the RA of the UE.

In an embodiment, by indicating S-NSSAIs values, the UE could use in a serving PLMN or SNPN in some of the TAs in the current registration area. Each S-NSSAI in the partially allowed NSSAI is associated with a list of TAs where the S-NSSAI is supported. When the S-NSSAI is received, the S-NSSAI rejected partially in the RA is stored in the UE while an RM-REGISTERED until the UE moves out of the current registration area or until the S-NSSAI is deleted.

In an embodiment, a network slice may be supported in one or more TAs in a PLMN/SNPN. A partial network slice support in a registration area for the UE includes configuring the UE with the partially allowed NSSAI and/or S-NSSAI(s) rejected partially in the RA. When creating the registration area for the UEs registering over the 3GPP access and supporting the partial network slice support in the registration area, an AMF entity may consider a trade-off between signalling for paging in TAs where the S-NSSAI is not supported versus the signalling for mobility registration updates to register with the S-NSSAI in the TA(s) where the S-NSSAI is supported, so that the AMF entity may create a registration area including the TA(s) where the requested S-NSSAI is not supported. For such S-NSSAI:
1. When requested by the UE from the TA where the S-NSSAI is not supported, then the S-NSSAI is included either in the partially allowed NSSAI or the AMF entity rejects the S-NSSAI partially in the RA.

When the S-NSSAI is subject to a NSAC for maximum number of UEs, then the AMF entity sends the S-NSSAI as rejected partially in the RA.
2. When requested by the UE from the TA where the S-NSSAI is supported, the S-NSSAI is included in the partially allowed NSSAI.
3. When the S-NSSAI is subjected to the NSAC for maximum number of UEs, then the AMF entity restricts the RA so that the S-NSSAI is supported in all the TAs of the RA and includes the S-NSSAI in the allowed NSSAI.
4. In an embodiment, whether the AMF entity for supporting the UEs uses the partially allowed NSSAI or rejects the S-NSSAIs partially in the RA is a per S-NSSAI decision which is based on AMF entity local policy. When supported and allowed by the local policy, the partially allowed NSSAI and the S-NSSAIs rejected partially in the RA may be applied simultaneously for the UE for different S-NSSAIs. While the S-NSSAIs of the allowed NSSAI are supported in all the TAs of the registration area, the S-NSSAIs of the partially allowed NSSAI are supported only in the TAs corresponding to the list of TAs (which are subset of the list of TAIs forming the registration area) associated with the S-NSSAI.

In an embodiment, when the UE supports partial network slice support in the registration area, the AMF entity creates the registration area for the UE considering the support of the S-NSSAIs of the requested NSSAI in the current TA and in the neighbouring TAs and provides to the UE in the registration accept message or in the UE configuration update command message the partially allowed NSSAI or the S-NSSAIs rejected partially in the RA as follows:
1. When one or more of the requested S-NSSAI(s) are supported in the subset of the TAs of the (potential) Registration Area, the AMF entity may include such S-NSSAI(s) in the partially allowed NSSAI and corresponding mapping information of the S-NSSAI(s) of the partially allowed NSSAI to the Home Public Land Mobile Network (HPLMN) S-NSSAI(s). For each S-NSSAI of the partially allowed NSSAI the AMF entity provides the list of TAs where the S-NSSAI is supported. The UE is considered registered with the S-NSSAI in the whole registration area. The AMF entity also provides the partially allowed NSSAI (without indication of the TA list where the partially allowed S-NSSAIs are supported) to the NG-RAN together with the UE's context.
2. Alternatively, the AMF entity may reject the S-NSSAI(s) with reject cause indicating “partially in the RA”. For each S-NSSAI of the S-NSSAIs rejected partially in the RA the AMF entity provides the list of TAs for which the S-NSSAI is supported or not supported.

In an embodiment, when the UE requests an S-NSSAI in a cell of a TA where the NS-AoS of the S-NSSAI does not match deployed tracking areas, the AMF entity includes the S-NSSAI in the allowed NSSAI or partially allowed NSSAI. When the UE stores partially allowed NSSAI the following applies:
1. the UE is considered registered with the S-NSSAI of the partially allowed NSSAI in the whole registration area. The UE does not trigger registration when moving between the TAs of support and non-support for the S-NSSAI within the RA.
2. The UE is allowed to initiate PDU session establishment for the S-NSSAI only when the UE is in the TA where the S-NSSAI is supported.
3. When the UE has already established a PDU session with the S-NSSAI part of the partially allowed NSSAI, the UE is allowed to activate the user plane resources of the PDU session only when the UE is in the TA part of the list of TAs associated with each S-NSSAI.
4. When the user plane resources are activated for a PDU session to the S-NSSAI part of the partially allowed NSSAI and the UE moves to the TA which is not part of the list of TAs associated with the S-NSSAI, the user plane resources for the PDU session is deactivated, but the PDU session context in the UE and a Session Management Function (SMF) entity is not released. The user plane resources for the PDU session is not activated as long as the UE is located in the TA which is not part of the list of TAs associated with the S-NSSAI of the partially allowed NSSAI.

When the UE stores the S-NSSAI rejected partially in the RA with the associated list of TAs, the UE is allowed to initiate a mobility registration update procedure to request registration with the S-NSSAI only when the UE is in the TA supporting the S-NSSAI.

In an embodiment, the method can be used to update partially allowed and/or the S-NSSAIs rejected partially in the registration area and/or S-NSSAI location availability information or Allowed NSSAI list. While updating the NSSAI list, if the Registration Area is updated such that none of the TAIs support the S-NSSAI part of partially allowed NSSAI list and/or the S-NSSAIs rejected partially in the Registration Area and/or S-NSSAI location availability information then network function e.g., AMF entity and/or UE can remove the S-NSSAI from the partially allowed NSSAI list and/or the S-NSSAIs rejected partially in the Registration Area and/or S-NSSAI location availability information and include the S-NSSAI as part of the Rejected NSSAI list for the current Registration Area. In an embodiment, if the Registration Area is updated such that all of the TAIs support the S-NSSAI part of rejected partially in the Registration Area, then the network function entity e.g., AMF entity and/or the UE can remove the S-NSSAI from the rejected partially in the Registration Area and/or partially allowed NSSAI list and/or S-NSSAI location availability information and include the S-NSSAI as part of the Allowed NSSAI list.

Also, an EPS in these embodiments can also be referred to as S1-mode or E-UTRAN or LTE system. A 5GS in these embodiments can also be referred to as N1-mode or NR or NG-RAN or 5G.

In one embodiment, if supported tracking area(s)/cells of partially allowed NSSAI and/or the S-NSSAIs rejected partially in the Registration Area and/or S-NSSAI location availability information is being deleted from the current registration area then the UE may delete the partially allowed NSSAI list and/or the S-NSSAIs rejected partially in the RA or update the supported list of TAs for corresponding NSSAI in the partially allowed NSSAI list and/or the S-NSSAIs rejected partially in the Registration Area. For example:
a) The UE is configured using NAS message with S-NSSAI-1 and supported TAI's as TAI-1, TAI-2 in the partially allowed NSSAI list. The TAI list is TAI-1, TAI-2, TAI-3, TAI-4
b) The UE receives the NAS message, for example, the UE configuration update message with the TAI-list as TAI-2, TAI-3, TAI-4.
c) The UE updates the partially allowed NSSAI list, with S-NSSAI-1 and supported TAI's as TAI-2.

In another embodiment:
a) The UE is configured using the NAS message with S-NSSAI-1 and supported TAI's as TAI-1, TAI-2 in the partially allowed NSSAI list. The TAI list is TAI-1, TAI-2, TAI-3, TAI-4.
b) The UE receives the NAS message, for example, the UE configuration update message with the TAI-list as TAI-3, TAI-4.
c) The UE updates the partially allowed NSSAI list, with S-NSSAI-1 and not supported TAI's as TAI-1, TAI-2 or removes S-NSSAI-1 entry from the partially allowed NSSAI list. In this case, the network function entity can also update and include S-NSSAI-1 into the rejected NSSAI list for the current registration area as none of the TAIs of the TAI list support the S-NSSAI.

For example:
a) The UE is configured using the NAS message with S-NSSAI-1 and NOT supported TAI's as TAI-1, TAI-2 in S-NSSAIs rejected partially in the Registration Area. The TAI list is TAI-1, TAI-2, TAI-3, TAI-4.
b) The UE receives the NAS message for example, the UE configuration update message with the TAI-list as TAI-2, TAI-3, TAI-4.
c) The UE updates the S-NSSAIs rejected partially in the Registration Area, with S-NSSAI-1 and not supported TAI's as TAI-2.

For example
a) The UE is configured using the NAS message with S-NSSAI-1 and NOT supported TAI's as TAI-1, TAI-2 in S-NSSAIs rejected partially in the Registration Area. The TAI list is TAI-1, TAI-2, TAI-3, TAI-4.
b) The UE receives NAS message for example, the UE configuration update message with the TAI-list as TAI-3, TAI-4.
c) The UE updates the S-NSSAIs rejected partially in the Registration Area, with S-NSSAI-1 and not supported TAI's as TAI-1, TAI-2 or removes S-NSSAI-1 entry from S-NSSAIs rejected partially in the Registration Area.

In yet another embodiment, whenever the network is updating the Registration Area (i.e., TAI) then the network also updates the partially allowed NSSAI list and/or the S-NSSAIs rejected partially in the Registration Area and/or S-NSSAI location availability information correspondingly to have aligned information. For example:
a) The UE is configured using the NAS message with S-NSSAI-1 and supported TAI's as TAI-1, TAI-2 in partially allowed NSSAI list. The TAI list is TAI-1, TAI-2, TAI-3, TAI-4,
b) If the network function entity for example, the AMF entity sends the NAS message for example, the UE configuration update message with TAI-list as TAI-2, TAI-3, TAI-4 then the UE updates the partially allowed NSSAI list, with S-NSSAI-1 and supported TAI's as TAI-2.
a) The UE is configured using the NAS message with S-NSSAI-1 and NOT supported TAI's as TAI-1, TAI-2 in S-NSSAIs rejected partially in the Registration Area. The TAI list is TAI-1, TAI-2, TAI-3, TAI-4,
b) If the network function entity for example, the AMF entity sends the NAS message for example, the UE configuration update message with TAI-list as TAI-3, TAI-4 then the UE updates S-NSSAIs rejected partially in the Registration Area and removes the S-NSSAI-1 entry. Then the network can add the S-NSSAI into the allowed NSSAI list because all the TAIs on which it was not supported are removed from the TAI list.

In another embodiment, the UE is configured using the NAS message with S-NSSAI-1 and supported cells as cell-1, cell-2 in S-NSSAI location availability information. The TAI list is TAI-1, TAI-2, TAI-3, TAI-4.

If the network function entity for example, the AMF entity sends the NAS message for example, the UE configuration update message with TAI-list as TAI-2, TAI-3, TAI-4 then the UE updates S-NSSAI location availability information, with S-NSSAI-1 and supported cells of TAI-2, TAI-3, TAI-4 and/or not supported cells of TAI-2, TAI-3, TAI-4.

In another embodiment: the UE is configured using NAS message with S-NSSAI-1,S-NSSAI-2 in Allowed NSSAI list. The TAI list is TAI-2, TAI-3, TAI-4.

If the network function entity for example, the AMF entity sends NAS message for example, the UE configuration update message with TAI-list as TAI-1, TAI-2, TAI-3, TAI-4, then the UE updates/adds the partially allowed NSSAI list, with S-NSSAI-1 and supported TAI's as TAI-2, TAI-3, TAI-4 and not supported TAI as TAI-1. Remove S-NSSAI-1 from allowed NSSAI list.

In the embodiment, based on the updated TAI list, the UE and the network function entity, for example, the AMF entity can update implicitly without peer to peer signalling the allowed NSSAI list/partially allowed NSSAI list and S-NSSAIs rejected partially in the Registration Area and/or S-NSSAI location availability information list based on the embodiment discussed in the disclosure. i.e., the examples described that the AMF entity updates the information into the UE, but this can be implicitly updated by the UE and the AMF entity.

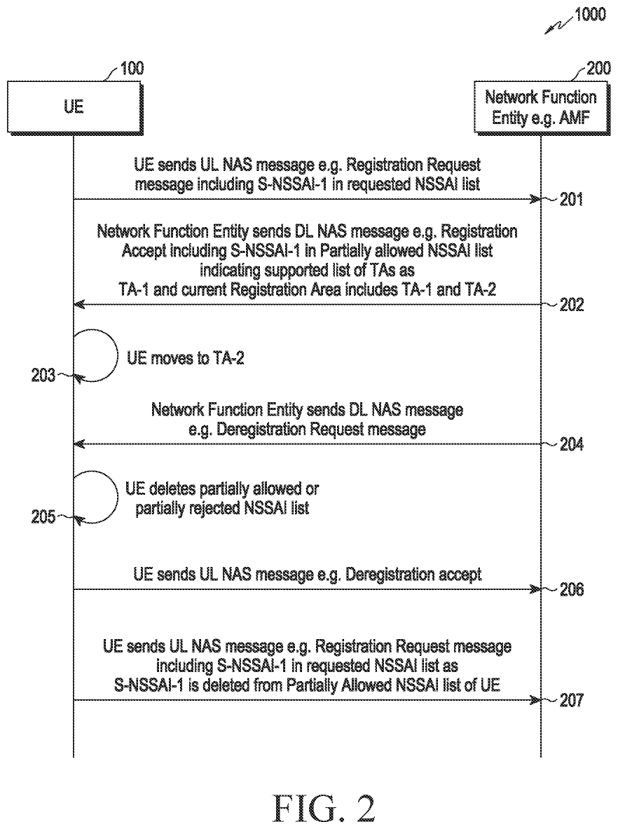

Referring now to the drawings, and more particularly to FIGS. 2 through 5, where similar reference characters denote corresponding features consistently throughout the figures, there are shown at least one embodiment.

FIG. 2 illustrates a sequence diagram depicting a scenario of the UE (100) deleting the partially allowed list and/or the S-NSSAIs rejected partially in the RA in the wireless network (1000), according to the embodiments as disclosed herein. At step 1, the UE (100) sends the UL NAS message, for example the registration request message including S-NSSAI-1 in the requested NSSAI list. At step 2, in response to the UL NAS message, the network function entity (200) sends the DL NAS message, for example, the registration accept including S-NSSAI-1 in the partially allowed NSSAI list and/or the S-NSSAIs rejected partially in the RA indicating supported list of Tas as TA-1 and current Registration Area includes TA-1 and TA-2 and/or the S-NSSAIs rejected partially in the RA. At step 3, the UE (100) moves to TA-2 (S-NSSAI not supported area) from TA-1. At step 4, the network function entity (200) sends the DL NAS message, for example, the deregistration request message to the UE (100). At step 5, the UE (100) deletes the partially allowed NSSAI list and/or the S-NSSAIs rejected partially in the RA. At step 6, the UE (100) sends the UL NAS message, for example, the deregistration accept to the network function entity (200). At step 7, the UE (100) sends the UL NAS message, for example, the registration request message including S-NSSAI-1 in the requested NSSAI list as S-NSSAI-1 is deleted from the partially allowed NSSAI list and/or the S-NSSAIs rejected partially in the RA of the UE (100).

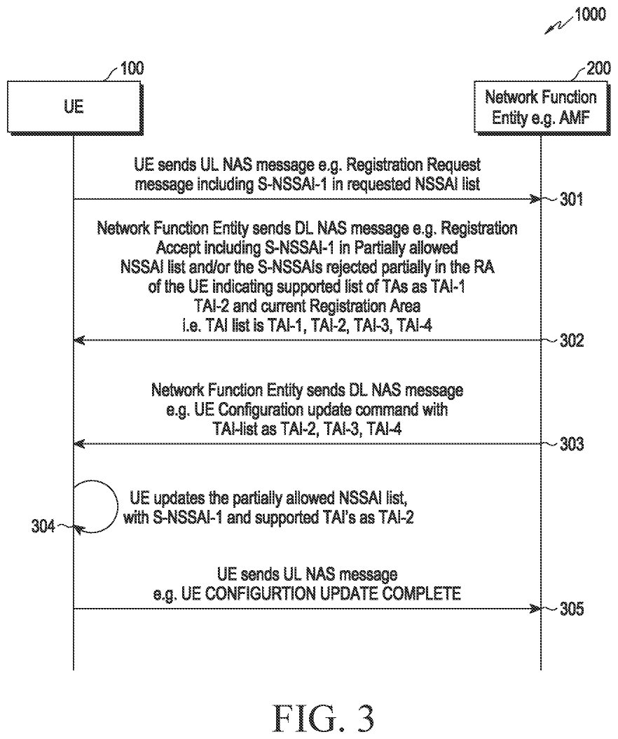

FIG. 3 illustrates the solution where the stored S-NSSAI is deleted from the partially allowed NSSAI list and/or the S-NSSAIs rejected partially in the RA of the UE in the wireless network (1000), according to embodiments as disclosed herein.

At step 1, the UE (100) sends the UL NAS message, for example, the Registration Request message including S-NSSAI-1 in the requested NSSAI list to the network function entity (e.g., AMF entity or the like) (200). At step 2, the network function entity (200) sends the DL NAS message, for example, the Registration Accept including S-NSSAI-1 in the partially allowed NSSAI list and/or the S-NSSAIs rejected partially in the RA of the UE indicating supported list of Tas as TAI-1, TAI-2 and the current Registration Area (that is the TAI list is TAI-1, TAI-2, TAI-3, TAI-4) to the UE (100).

At step 3, the network function entity (200) sends the DL NAS message, for example, the UE Configuration update command with the TAI-list as TAI-2, TAI-3, TAI-4 to the UE (100). At step 4, the UE (100) updates the partially allowed NSSAI list, with S-NSSAI-1 and supported TAI's as TAI-2. At step 5, the UE (100) sends the UL NAS message, for example, the UE CONFIGURATION UPDATE COMPLETE to the network function entity (e.g., AMF entity or the like) (200).

In one embodiment, the UE (100) can delete the partially allowed NSSAI list and/or the S-NSSAIs rejected partially in the RA when the UE (100) changes current registration area (i.e., when the UE (100) moves out of the registration area).

In another embodiment, the UE (100) can delete the partially allowed NSSAI list and/or the S-NSSAIs rejected partially in the RA when the UE (100) is switched off or the USIM is removed or a new USIM is inserted (i.e., if USIM-1 is removed and re-inserted the lists are not deleted otherwise if a new USIM is inserted the lists are deleted).

In yet another embodiment the UE (100) may delete the partially allowed NSSAI list and/or the S-NSSAIs rejected partially in the RA when the UE (100) enters into a 5GMM-DEREGISTERED or an EMM-DEREGISTERED state.

In one embodiment, whenever the UE (100) has to delete the current Registration Area, for example, when registration reject, the tracking area update reject message is received by the UE (100) and all other existing method conditions as described in TS 24.501 which leads UE (100) to delete the Registration Area (also referred to as TAI list in the existing method), the UE (100) has to delete the partially allowed NSSAI list and/or the S-NSSAIs rejected partially in the RA for the corresponding Registration Area or entry in the partially allowed NSSAI list and/or the S-NSSAIs rejected partially in the RA corresponds to the deleted tracking area(s) (which is a part of the deleted Registration Area). For example let's consider the UE (100) is being configured S-NSSAI-1 as partially allowed NSSAI and/or the S-NSSAIs rejected partially in the Registration Area and corresponding supported tracking area is configured as TA-1 for S-NSSAI-1. Now the UE (100) triggers the UL NAS message, for example, the registration request message indicating “mobility registration updating” in the 5GS registration type IE of the REGISTRATION REQUEST message and Network sends the DL NAS message, for example, the registration reject message, for example, cause #3, #6, #7, #11, #12, #13, #15. In this case, the UE (100) may delete the partially allowed NSSAI and/or the S-NSSAIs rejected partially in the Registration Area as the current Registration area has to be deleted.

The UE (100) deletes the partially allowed NSSAI list and/or the S-NSSAIs rejected partially in the RA or the corresponding S-NSSAI entry in the partially allowed NSSAI list and/or the S-NSSAIs rejected partially in the RA when the UE (100) performs an intersystem change to the EPS (i.e., S1 mode or E-UTRA or LTE) or from the EPS to the 5GS. In an example,
a) When the UE (100) gets the TAU accept or the TAU reject in the EPS after intersystem change from the 5GS.
b) When the UE (100) performs the intersystem change to the EPS from the 5GS.
c) When the UE (100) performs the intersystem change to the 5GS from the EPS
d) When the UE (100) gets registration accept after intersystem change to the 5GS from the EPS.

The UE (100) maintains the partially allowed NSSAI list and/or the S-NSSAIs rejected partially in the RA or the corresponding S-NSSAI entry in the partially allowed NSSAI list and/or the S-NSSAIs rejected partially in the RA when the UE (100) performs the intersystem change to the EPS (i.e., S1 mode or E-UTRA or LTE) or from the EPS to the 5GS. In an example,
a) when the UE (100) gets TAU accept or TAU reject in the EPS after intersystem change from the 5GS;
b) When the UE (100) performs the intersystem change to the EPS from the 5GS;
c) When the UE (100) performs the intersystem change to the 5GS from the EPS; and
d) When the UE (100) gets registration accept after the intersystem change to the 5GS from the EPS.

The UE (100) can maintain the partially allowed NSSAI list and/or the S-NSSAIs rejected partially in the RA or the corresponding S-NSSAI entry in the partially allowed NSSAI list and/or the S-NSSAIs rejected partially in the RA when PDN connected with corresponding S-NSSAI has been established in EPC, for example, when the UE (100) receives the ACTIVATE DEFAULT EPS BEARER CONTEXT REQUEST message provided with S-NSSAI and the PLMN ID in the Protocol configuration options Information Element (IE) or Extended protocol configuration options IE.

The UE (100) can delete the partially allowed NSSAI list and/or the S-NSSAIs rejected partially in the RA or the corresponding S-NSSAI entry in the partially allowed NSSAI list and/or the S-NSSAIs rejected partially in the RA when the PDN connected with corresponding S-NSSAI has been established in EPC, for example, when the UE (100) receives the ACTIVATE DEFAULT EPS BEARER CONTEXT REQUEST message provided with S-NSSAI and the PLMN ID in the Protocol configuration options IE or Extended protocol configuration options IE.

The UE (100) can maintain the partially allowed or partially rejected NSSAI list or the corresponding S-NSSAI entry in the partially allowed or partially rejected NSSAI list when the PDN connected with corresponding S-NSSAI has been rejected in the EPC, for example, if cause indicates (S-)NSSAI is not allowed.

In another embodiment, the UE (100) can delete the partially allowed or partially rejected NSSAI list or the corresponding S-NSSAI entry in the partially allowed or partially rejected NSSAI list when the PDN connected with the corresponding S-NSSAI has been rejected in the EPC, for example, if cause indicates (S-)NSSAI not allowed.

In an embodiment, the partially allowed NSSAI list and/or the S-NSSAIs rejected partially in the AMF entity performs deletion of S-NSSAI-1 from the partially allowed NSSAI list and/or the S-NSSAIs rejected partially in the RA and sends the UL NAS message, for example, the registration request message including S-NSSAI-1 in requested NSSAI list as S-NSSAI-1 is deleted from the partially allowed NSSAI list and/or the S-NSSAIs rejected partially in the RA of the UE (100).

In an embodiment, the partially allowed NSSAI list and/or the S-NSSAIs rejected partially in the UE (100) performs deleting of S-NSSAI-1 from the partially allowed NSSAI list and/or the S-NSSAIs rejected partially in the RA and sends the UL NAS message with registration request message including S-NSSAI-1 in the requested NSSAI list as the S-NSSAI-1 is deleted from the partially allowed NSSAI list of the UE (100).

In this embodiment, The S-NSSAI is deleted from the partially allowed NSSAI list and/or the S-NSSAIs rejected partially in the RA implies at least one of: the only value of S-NSSAI-1 is removed from the respective partially allowed NSSAI list/S-NSSAIs rejected partially in the RA or the complete partially allowed NSSAI list/S-NSSAIs rejected partially in the RA is deleted or removed.

In this embodiment, the S-NSSAIs rejected partially in the RA is also referred to as partially rejected NSSAI. In general these S-NSSAIs represent the set of S-NSSAI along with the set of TAIs where the respective S-NSSAI is not supported. Similarly, the partially allowed NSSAI list can be referred to by any name but this represents the set of the S-NSSAI(s) along with the TAIs where the respective S-NSSAI is supported.

Note that the EPS in the patent disclosure can also be referred to as S1-mode or E-UTRAN or LTE system. The 5GS in the patent disclosure can also be referred to as N1-mode or NR or NG-RAN or 5G.

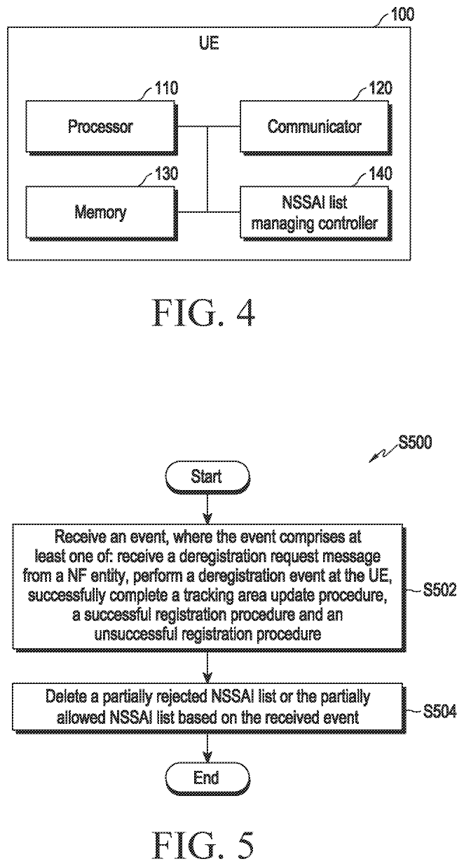

FIG. 4 illustrates various hardware components of the UE (100), according to the embodiments as disclosed herein. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The wireless network (1000) can be, for example, but not limited to a fourth generation (4G) network, a fifth generation (5G) network, an Open Radio Access Network (ORAN) or the like.

In an embodiment, the UE (100) includes a processor (110), a communicator (120), a memory (130) and a NSSAI list managing controller (140). The processor (110) is coupled with the communicator (120), the memory (130) and the NSSAI list managing controller (140).

The NSSAI list managing controller (140) receives at least one event. The at least one event comprises at least one of: receive the deregistration request message from the network function (NF) entity (200), perform a deregistration event at the UE (100), successfully complete a tracking area update procedure, a successful registration procedure, or an unsuccessful registration procedure. Further, the NSSAI list managing controller is configured to delete a partially rejected NSSAI list based on the at least one received event.

In an embodiment, the tracking area update procedure is successfully completed by performing an intersystem change from an N1 mode to an S1 mode, sending a Tracking Area Update (TAU) request message to the NF entity while performing the intersystem change from the N1 mode to the S1 mode, and receiving one of: a TAU accept message or a TAU reject message based on the TAU request message.

In an embodiment, the successful registration procedure or the unsuccessful registration procedure is performed when the UE (100) moves out of a registration area. The UE (100) enters at least one of: the 5GMM-DEREGISTERED state or the 5GMM-REGISTERED state.

In an embodiment, the NSSAI list is received over a DL NAS message, wherein the DL NAS message is the UE configuration update command message or registration accept message.

In an embodiment, the deregistration event performed at the UE (100) is due to a UE initiated deregistration procedure or a network initiated deregistration procedure.

The NSSAI list managing controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (140) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 4 shows various hardware components of the UE (100) but it is to be understood that other embodiments are not limited thereon. In other embodiments, the UE (100) may include less or a greater number of components. Further, the labels or names of the components are used only for illustrative purpose and does not limit the scope of the disclosure. One or more components can be combined together to perform same or substantially similar function in the UE (100).

FIG. 5 illustrates a flow chart (S500) depicting a method for managing an NSSAI list in the wireless network (1000), according to the embodiments as disclosed herein. The operations (S502-S504) are handled by the NSSAI list managing controller (140).

At S502, the method includes receiving the event. The event includes at least one of: receive a deregistration request message from the NF entity (200), perform a deregistration event at the UE (100), successfully complete a tracking area update procedure, a successful registration procedure or an unsuccessful registration procedure. At S504, the method includes deleting the partially rejected NSSAI list or the partially allowed NSSAI list based on the received event. The proposed method helps the UE (100) to maintain the partially rejected NSSAI.

The various actions, acts, blocks, steps, or the like in the flow chart (S500) may be performed in the order presented, in a different order or simultaneously. Further, in some embodiments, some of the actions, acts, blocks, steps, or the like may be omitted, added, modified, skipped, or the like without departing from the scope of the disclosure.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for managing a network slice selection assistance information (NSSAI) in a wireless network, the method comprising:
deleting, by a user equipment (UE), a partially rejected NSSAI in case that at least one event occurs,
wherein the at least one event comprises at least one of:
performing, by the UE, a deregistration process,
successfully completing, by the UE, a tracking area update procedure, or
performing, by the UE, a successful registration procedure.

2. The method of claim 1, wherein the tracking area update procedure is successfully completed by performing an intersystem change from an N1 mode to an S1 mode.

3. The method of claim 1, wherein the successful registration procedure is performed in a new registration area.

4. The method of claim 1, wherein the at least one event further comprises performing an unsuccessful registration in a new registration area.

5. The method of claim 4, wherein the UE enters a 5GMM-DEREGISTERED state or a 5GMM-REGISTERED state after the unsuccessful registration.

6. The method of claim 1, wherein the partially rejected NSSAI is received in a configuration update command message or a registration accept message.

7. A User Equipment (UE) for managing a network slice selection assistance information (NSSAI) in a wireless network, the UE comprising:
a memory; and
at least one processor coupled with the memory, the at least one processor configured to:
delete a partially rejected NSSAI list in case that at least one event occurs,
wherein the at least one event comprises at least one of:
performing a deregistration process,
successfully completing a tracking area update procedure, or
performing a successful registration procedure.

8. The UE of claim 7, wherein to successfully complete the tracking area update procedure, the at least one processor is configured to perform an intersystem change from an N1 mode to an S1 mode.

9. The UE of claim 7, wherein the at least one processor is configured to perform the successful registration procedure in a new registration area.

10. The UE of claim 7, wherein the at least one event further comprises performing an unsuccessful registration procedure in a new registration area.

11. The UE of claim 10, wherein the at least one processor is configured to enter a 5GMM-DEREGISTERED state or a 5GMM-REGISTERED state after the unsuccessful registration procedure.

12. The UE of claim 7, wherein the partially rejected NSSAI is received in a configuration update command message or a registration accept message.
